(19) United States
(12) Patent Application Publication
(10) Pub. No.: US 2013/0097935 A1
(43) Pub. Date: Apr. 25, 2013

(54) SLIDING SHOWER DOOR ASSEMBLY

(71) Applicant: C.R. Laurence Company, Inc., Los Angeles, CA (US)

(72) Inventor: Gary Sprague, Los Angeles, CA (US)

(73) Assignee: C.R. Laurence Company, Inc., Los Angeles, CA (US)

(21) Appl. No.: 13/659,810

(22) Filed: Oct. 24, 2012

Related U.S. Application Data
(60) Provisional application No. 61/550,808, filed on Oct. 24, 2011.

(51) Int. Cl. E05D 15/12; E06B 3/46

(52) U.S. Cl. 49/425; 49/506

(57) ABSTRACT

A sliding door panel assembly comprises at least one movable door panel and a roller assembly. The roller assembly includes at least one roller mounted on an axle and at least one roller clamping plate receiving the axle. The vertical load of the door panel is substantially borne by the at least one roller. A track may be disposed beneath the roller assembly, and the roller is movable along the track. The door panel is movable by moving the roller along the track.

### CROSS-REFERENCE TO RELATED APPLICATION

This application claims priority to U.S. Provisional Application Ser. No. 61/550,808, filed Oct. 24, 2011, which is expressly incorporated by reference herein in its entirety.

### FIELD OF THE DISCLOSURE

The following disclosure relates to goal shot training systems and devices.

### BACKGROUND

Different types of sliding shower door assemblies are known. In a typical arrangement one or more doors are movable in parallel planes to form an enclosure comprising stationary walls and the shower doors. In such arrangements at least one shower door is slidable between an open position, allowing user access to the shower enclosure and a closed position. A common element is that it is desired to retain water within the enclosure rather than leaking out into the surrounding area.

In a known shower door assembly, the load of the sliding door is borne by a header assembly. In such an assembly, a track is provided and one or more carriers are attached to the sliding door. The weight of the door is borne by the carrier, which in turn is borne by the track. There exists a need for a need for an economical and aesthetically pleasing sliding shower door assembly in which the load of the sliding door is borne by the bottom portion of the sliding door, rather than the header.

### SUMMARY

Embodiments of the present disclosure alleviate to a great extent the disadvantages of known sliding shower door assemblies, some of which are discussed above, by providing a bottom rolling sliding shower door assembly. A shower door panel is supported on a track in a base of the shower door assembly. In one embodiment, a generally non-load bearing stabilization assembly is provided at the top side of the sliding panel.

In exemplary embodiments, a sliding door panel assembly comprises at least one movable door panel and a roller assembly. The roller assembly includes at least one roller mounted on an axle and at least one roller clamping plate receiving the axle. Exemplary embodiments may further comprise at least one guard plate disposed outside the at least one roller clamping plate. The vertical load of the door panel may be substantially borne by the at least one roller.

Exemplary embodiments may further comprise a track disposed beneath the roller assembly, such as on a floor, sill, curb or tub edge, and the roller may be movable along the track. In exemplary embodiments, the door panel is movable by moving the roller along the track. The sliding door panel assembly may further comprise a top guide in contact with a top portion of the door panel. The sliding door panel assembly may further comprise a roller height adjustment mechanism.

Exemplary embodiments include a sliding door system comprising at least one slidable door panel, a roller assembly, and a track disposed beneath the roller assembly. At least one roller is mounted on an axle, and at least one roller clamping plate receives the axle. The system may further comprise at least one guard plate disposed outside the at least one roller clamping plate. The vertical load of the door panel is substantially borne by the at least one roller.

In exemplary embodiments, the roller is movable along the track, and the door panel is slidable by moving the roller along the track. The system may further comprise a top guide in contact with a top portion of the slidable door panel. In exemplary embodiments, the system further comprises a roller height adjustment mechanism. The system may further comprise a second door panel, which may be in a fixed position. The second door panel may be mounted on a substantially u-shaped track.

Exemplary embodiments include a method of sliding a door panel comprising mounting a roller on an axle, providing a roller clamping plate to receive the axle, disposing at least one door panel into the roller such that the vertical load of the door panel is substantially borne by the at least one roller, and sliding the door panel by moving the roller along a track disposed beneath the roller. Exemplary methods may further comprise disposing a guard plate outside the roller clamping plate. In exemplary methods, the door panel may be stabilized by providing a top guide in contact with a top portion of the door panel. Exemplary methods may further comprise adjusting the height of the roller.

These and other features and advantages of the present invention will be appreciated from the following detailed description of the invention and the accompanying figures.

### BRIEF DESCRIPTION OF THE DRAWINGS

Drawings depicting the sliding shower door assembly are provided herewith (31 sheets).

FIG. 1A is a front view of an exemplary embodiment of a sliding door panel assembly in accordance with the present disclosure;

FIG. 1B is a top view of an exemplary embodiment of a sliding door panel assembly in accordance with the present disclosure;

FIG. 2 is a front view of an exemplary embodiment of a sliding door panel assembly in accordance with the present disclosure;

FIG. 3 is a cross-sectional view of an exemplary embodiment of a sliding door panel assembly in accordance with the present disclosure;

FIG. 4 is a front view of an exemplary embodiment of a sliding door panel assembly in accordance with the present disclosure;

FIG. 5 is a cross-sectional view of an exemplary embodiment of a sliding door panel assembly in accordance with the present disclosure;

FIG. 6 is a front view of an exemplary embodiment of a sliding door panel assembly in accordance with the present disclosure;

FIG. 7 is a cross-sectional view of an exemplary embodiment of a sliding door panel assembly in accordance with the present disclosure; and

FIG. 8 is a cross-sectional view of an exemplary embodiment of a sliding door panel assembly in accordance with the present disclosure.

It will be recognized that some or all of the figures are representations for purposes of illustration and do not necessarily depict the actual relative sizes or locations of the elements shown.

### DETAILED DESCRIPTION

In the following paragraphs, embodiments of the present invention will be described in detail by way of example with reference to the accompanying drawings. Throughout this description, the embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced feature(s).

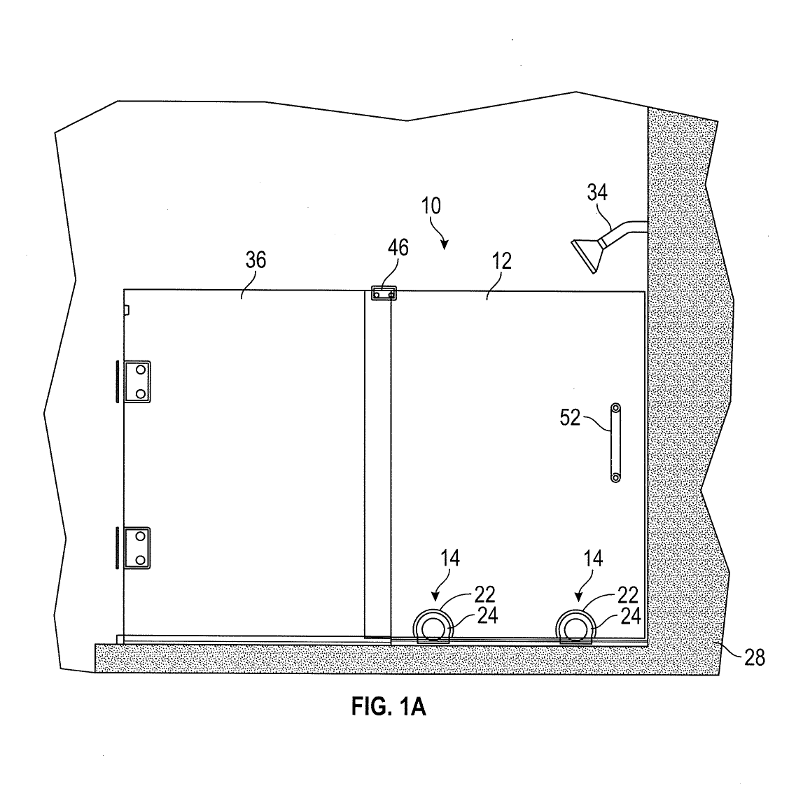

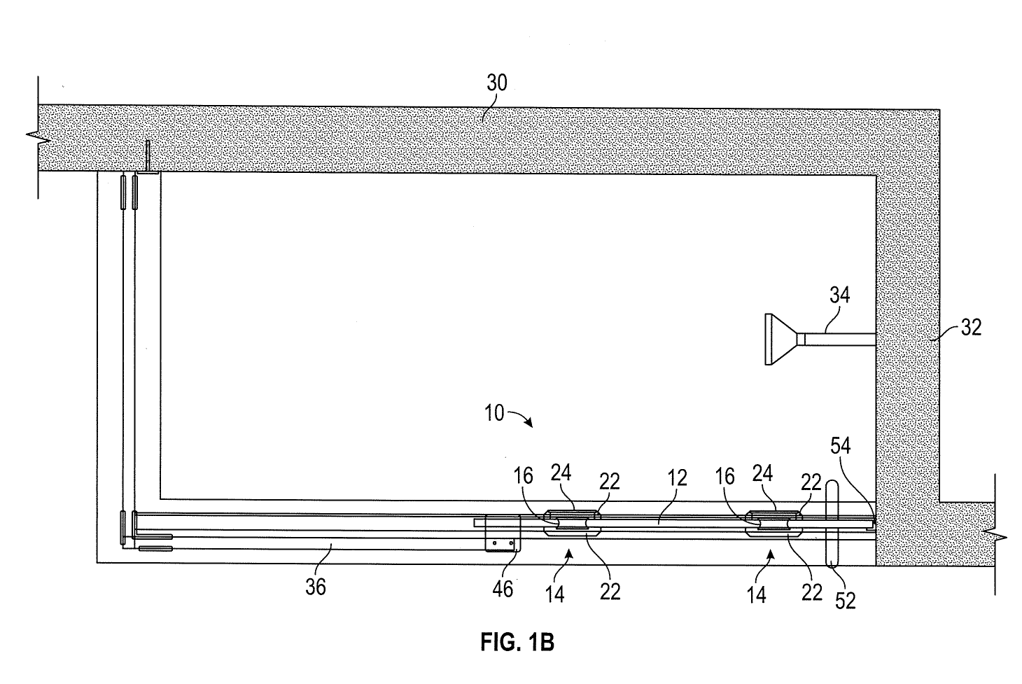

Referring to FIGS. 1A-3, an exemplary embodiment of a sliding door panel assembly 10 will be described. The assembly 10 includes a movable door panel 12 resting on a roller assembly 14. In an exemplary embodiment, the sliding door panel assembly 10 may be part of a sliding door panel assembly, such as a tub top door panel assembly or other types of assemblies. In this embodiment, the assembly 10 is positioned on a floor, sill, curb or tub top edge of a shower enclosure 28. As best seen in FIG. 1B, the shower enclosure 28 includes a lateral wall 30 and a first axial wall 32 positioned at a generally right angle to the lateral wall 30. The shower head 34 is mounted protruding from the first axial wall 32. It should be noted that any combination or profiles of fixed walls may be selected.

Also in exemplary embodiments, an optional second axial wall is formed by a fixed wall panel 36, which in a tub embodiment is mounted on an axially oriented top surface of the tub, and extending vertically from the axial top surface of the tub. In the illustrated elevational view, clamps or other affixing elements are provided to affix the panel 36 to a fixed wall, creating the fixed panel, although panel 36 also can be a wall as well. Optionally panel 36 can be a movable panel as well. The sliding shower door assembly is positioned on a longitudinally oriented top surface 38 of the sill, curb, floor or tub 40, that is at a generally right angle to the two axial walls 30, 32, and extends longitudinally between the two axial walls, which are spatially separated.

In exemplary embodiments, the sliding shower door assembly 10 includes two panels 12, 36, one substantially fixed relative to the surface 40 and any fixed walls. Alternatively, a single panel 12 is provided, and the other vertical surfaces are walls or panels. The fixed panel or wall 36 is positioned to engage the second axial wall 32, at a desired angle, such as a right angle for rectangular shower enclosures. To protect the edge of the sliding door panel 12 and help keep water within the shower enclosure 30, a jamb or door stop 54 may be provided. A door handle 52 may be provided on one or both of the fixed or sliding panel to facilitate movement of the panels.

An exemplary roller assembly 14 (or assemblies) includes at least one roller 16 mounted on an axle 18. In the illustrated roller assembly, two rollers 16 are provided, one on each side of the sliding panel 12. A roller clamping plate 22 receives the axle 18 that mounts the rollers 16, each roller being supported on one side. In exemplary embodiments, there is a roller clamping plate 22 on each side of the roller assembly 14. More particularly, a first roller clamping plate 22a receives one end of the axle 18, and a second roller clamping plate 22b receives the other end of the axle 18.

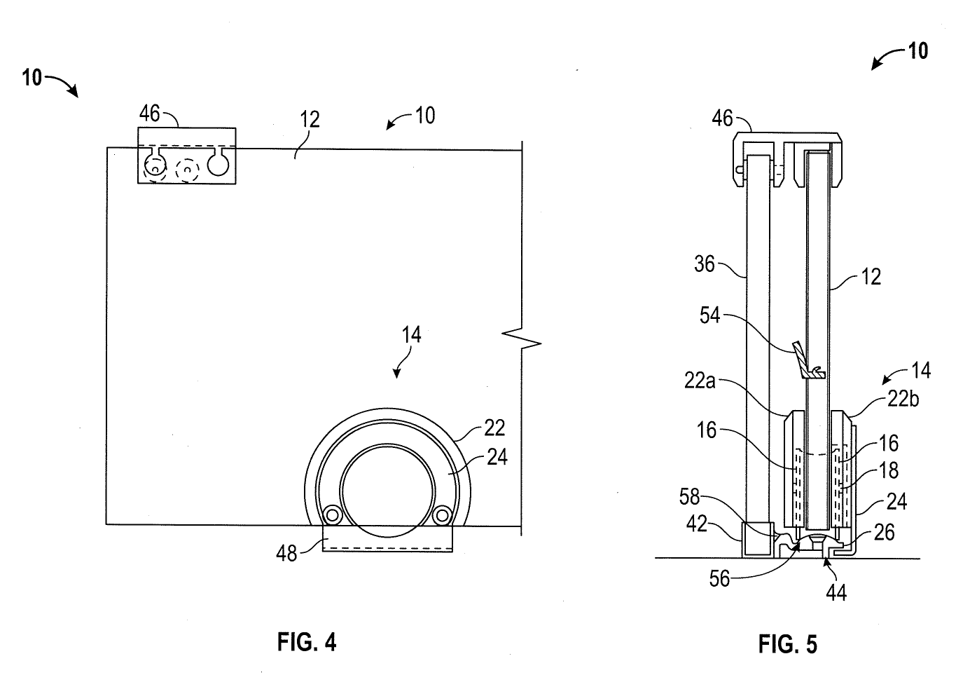

A guard plate 24 may be disposed outside one of the roller clamping plates 22b, and in exemplary embodiments, is an h-shaped plate (in cross sectional view). The guard plate 24 acts as a safety guard inhibiting external access to the rolling mechanism (such as finger access) or to prevent access between the roller 16 and the track 26. It also serves to prevent the roller 26 from lifting. It should be noted that a guard plate 24 could be provided for each side of the roller assembly 14 or a single guard plate for the outward facing side of the roller assembly. As best seen in FIG. 4, exemplary embodiments may also include a bottom track finger guard 48 for additional protection of the device and the user.

Advantageously, the weight of the sliding panel 12 is generally borne by the roller assembly or assemblies 14. More particularly, the load of the sliding panel 12 is supported on one or more roller assemblies 14 on its bottom edge. In exemplary embodiments, a track 26 is situated at the lower end of one or more shower door panels 12. In one embodiment, the sliding shower door assembly 10 is provided for a shower enclosure 28, in which the sliding door assembly 10 is positioned on track 26, which is positioned on surface 40, such as a floor, sill or curb. In one example the floor, sill or curb 40 can be tiled although any other surface that can support the track may be used. In another example of the embodiment, the sliding shower door assembly 10 is provided for a shower enclosure 28, in which the sliding door assembly 10 is positioned on a surface 40, such as a tub side, sill, curb, or floor 40. In these examples, a gutter 50 may also be provided to aid in water management. As best seen in FIG. 5, an optional seal 56 and sealant 58 on or near the track 26 can also contain water.

In an exemplary embodiment, the bottom of a fixed panel 36 is mounted on a u-shaped channel or track 42, such as best seen in the cross-sectional view in FIG. 3. As shown in FIG. 3, the fixed panel 36 is set into the u-track 42. The sliding panel 12 is movable on a roller assembly 14 mounted to the track 26. In the illustration the roller assembly 14 is fixed in a lateral direction relative to the track 26, although rolling elements are movable as well. It should be appreciated that any mechanism promoting relative motion of the sliding panel 12 and the fixed panel 36 may be selected. Optimally, the sliding door panel 12 in a closed position is in relative alignment with the wall against which it is closing.

With reference to FIGS. 3, 5 and 7, a roller height adjustment mechanism 44 will be described. In exemplary embodiments, the roller height adjustment mechanism 44 includes a rotatable member 45 directly underneath the track 26. To adjust the height of the rollers 16, the user rotates the rotatable member 45 clockwise, which raises the track 26, thereby raising the rollers 16 and the slidable panel 12 therein. Rotating the rotatable member counter-clockwise lowers the rotatable member 45, thereby lowering the track 26, the rollers 16 and the slidable panel 12. Utilizing the roller height adjustment mechanism 44, by raising or lowering panel relative to the rollers 16, sliding panel 12 may be aligned relative to the wall.

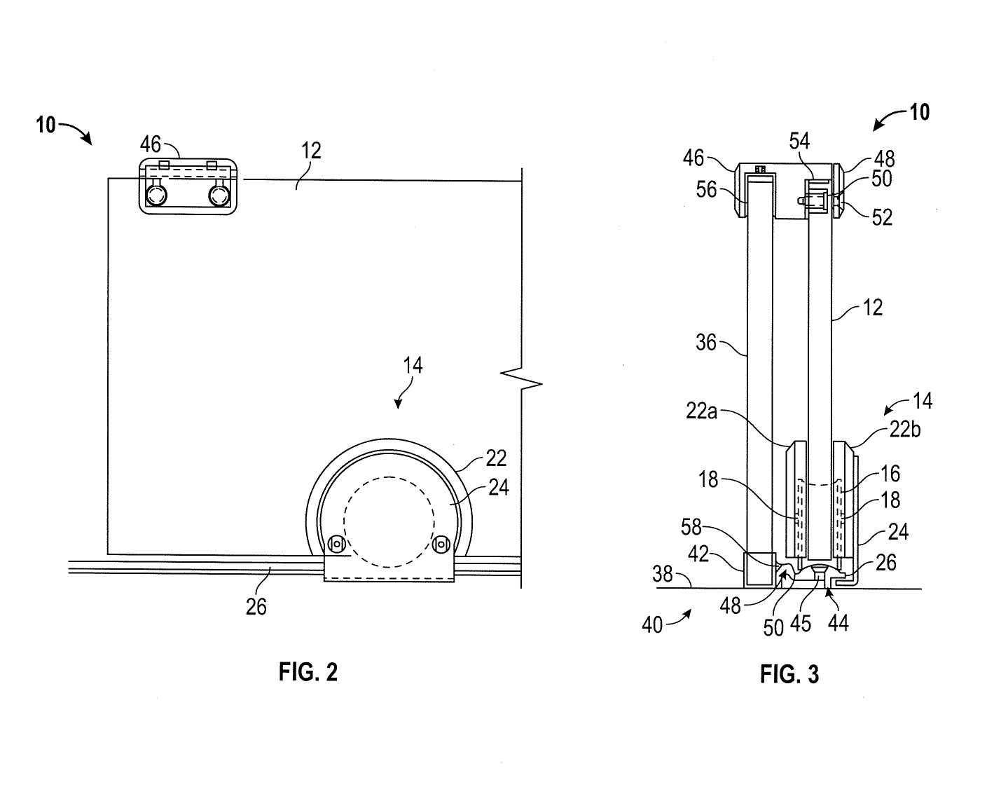

As shown in FIGS. 2-7, a top guide or support fitting 46 may be provided to stabilize the sliding panel 12, i.e., the top guide 46 serves as an axial support that inhibits the sliding panel 12 from falling over. Any material can be used for the top guide 46, such as a metal, or a plastic, and in exemplary embodiments, the inner surface that moves relative to a panel is made of a material that minimizes scratching or other physical wear of the panel.

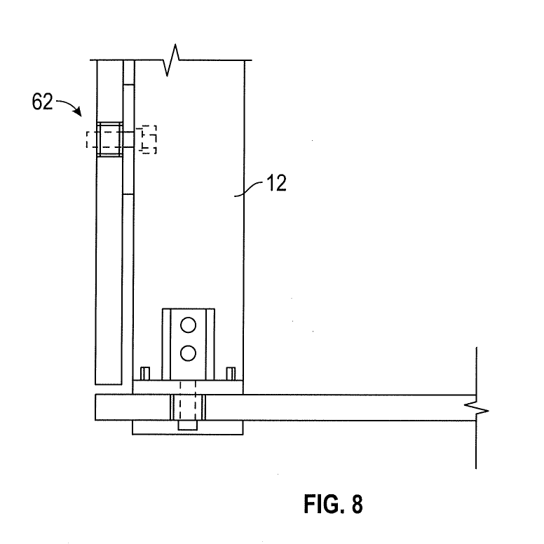

Additional components may be provided for the top guide 46 to improve the support function of both panels and/or facilitate relative movement of the sliding panel 12. For instance, as best seen in FIG. 3, exemplary embodiments may include a clamping plate 48, a bushing 50, and a clamping screw 52, which can be tightened to better support the panels 12, 36. Insulating gaskets 54 may also be provided, as well as an inner guide 56 to support the fixed panel 36. As shown in FIG. 8, a side fastening assembly 62 may also be provided to secure the slidable panel 12.

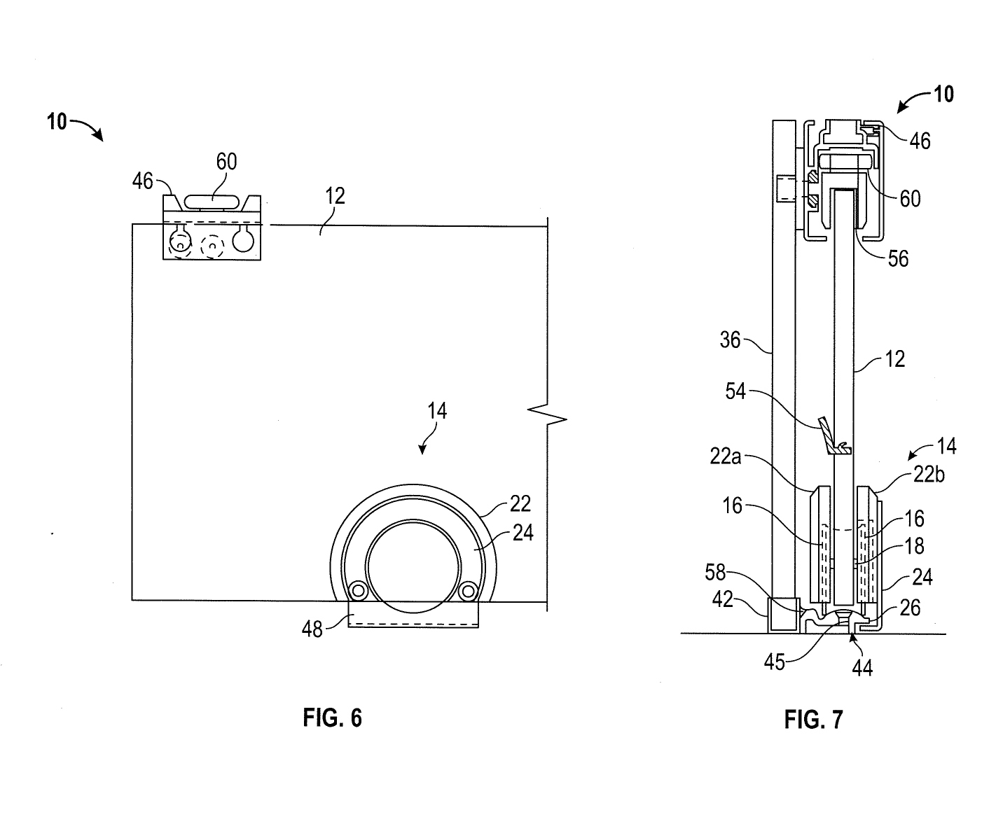

With reference to FIGS. 6-7, in an exemplary embodiment the inner surface incorporates at least one upper roller 60 to further promote the relative movement. In one embodiment, the top guide 46 is fixed to the sliding panel 12, e.g., via the clamping plate 48, a bushing 50, and a clamping screw 52, and when the sliding panel 12 moves, the top guide 46 slides over the fixed panel 36 as the sliding panel is moved by a user. Alternatively, the top guide 46 can be fixed relative to the fixed panel 36, and the sliding panel 12 moves relative to the fixed guide 46.

In operation, an exemplary sliding door panel assembly 10 may be assembled by first mounting the roller 16 on an axle 18. Next, the roller clamping plates 22a, 22b are placed adjacent the outside of the rollers 16 so they receive the axle 18. The roller assembly 14 is then placed onto a track 26. The sliding door panel 12 is disposed into the roller 16 such that the vertical load of the sliding panel 12 is supported on one or more roller assemblies 14 on the bottom edge. A fixed panel 36 may be provided and inserted into a u-track 42.

If additional protection is desired, a guard plate 24 may be disposed outside one or both of the roller clamping plates 22a, 22b. To move the sliding door panel 12, the user slides the roller 16 along the track 26 in a lateral direction relative to the track 26 back and forth between an open position and a closed position in which the sliding door panel 12 is in relative alignment with the wall against which it is closing. To stabilize the door panels, they may be positioned within a top guide 46 such that the top guide 46 is fixed relative to the fixed panel 36, and the sliding panel 12 moves relative to the fixed guide 46.

Thus, it is seen that sliding door panel assemblies, systems and methods are provided. It should be understood that any of the foregoing configurations and specialized components or chemical compounds may be interchangeably used with any of the systems of the preceding embodiments. Although exemplary embodiments of the present disclosure are described hereinabove, it will be evident to one skilled in the art that various changes and modifications may be made therein without departing from the disclosure. It is intended in the appended claims to cover all such changes and modifications that fall within the true spirit and scope of the disclosure.

1. A sliding door panel assembly comprising:
at least one movable door panel;
a roller assembly including:
at least one roller mounted on an axle;
at least one roller clamping plate receiving the axle;
the vertical load of the door panel being substantially borne by the at least one roller.

2. The sliding door panel assembly of claim 1 further comprising a track disposed beneath the roller assembly, the track mounted on a mounting surface.

3. The sliding door panel assembly of claim 1 further comprising:
a guard plate outside one the roller clamping plate inhibiting external access to the rolling mechanism or to inhibit access between the roller and a mounting element.

4. The roller assembly of claim 1 further comprising:
at least one additional roller mounted on the axle opposite the other roller;
a second guard plate, each guard plate positioned on the outside of the roller assembly adjacent one of said rollers;
roller clamping plates positioned on opposite sides of the roller assembly, a first roller clamping plate receiving one end of the axle and a second roller clamping plate receiving the other end of the axle.

5. The roller assembly of claim 1 wherein the guard plate has a generally L-shaped cross-sectional profile.

6. The sliding door panel assembly of claim 1 further comprising a roller height adjustment mechanism.

7. The sliding door panel assembly of claim 1 further comprising a track bearing the load carried by the roller assembly.

8. The sliding door panel assembly of claim 7 further comprising a top guide in contact with a top portion of the slidable door panel.

9. The sliding door panel assembly of claim 8 further comprising a roller height adjustment mechanism.

10. The sliding door panel assembly of 8 further comprising a fixed second door panel.

11. A shower enclosure including the sliding door panel assembly of claim 8 further including at least three walls that are in fixed relation to one another.

12. The system of claim 8 further comprising at least one guard plate disposed outside the at least one roller clamping plate.

13. A method of sliding a door panel, comprising:
mounting a roller on an axle;
providing a roller clamping plate to receive the axle;
disposing at least one door panel into the roller such that the vertical load of the door panel is substantially borne by the at least one roller; and
sliding the door panel by moving the roller along a track disposed beneath the roller.

14. The method of claim 13 further comprising disposing a guard plate outside the roller clamping plate.

15. The method of claim 13 further comprising stabilizing the door panel providing a top guide in contact with a top portion of the door panel.

16. The method of claim 13 further comprising adjusting the height of the roller.

17. A roller assembly comprising:
at least one roller mounted on an axle;
a roller clamping plate receiving the axle;
a guard plate outside one the roller clamping plate acting as a safety guard inhibiting external access to the rolling mechanism or to inhibit access between the roller and a mounting element.

18. The roller assembly of claim 17 further comprising:
at least one additional roller mounted on the axle opposite the other roller;
a second guard plate, each guard plate positioned on the outside of the roller assembly adjacent one of said rollers;
roller clamping plates positioned on opposite sides of the roller assembly, a first roller clamping plate receiving one end of the axle and a second roller clamping plate receiving the other end of the axle.

19. The roller assembly of claim 17 wherein the guard plate has a generally L-shaped cross-sectional profile.

20. The sliding door panel assembly of claim 1 further comprising a fixed second door panel and a top guide in contact with a top portion of the fixed door panel.
